(19) United States
(12) Patent Application Publication
(10) Pub. No.: US 2005/0040946 A1
(43) Pub. Date: Feb. 24, 2005

(54) Remotely activated tree stand location device

(76) Inventors: Gary Hogg, Princeton, KY (US); David Hsu, Taipei (TW); Eric Wang, Taipei (TW)

Correspondence Address: James M. Robertson, 233 South Pine Street, Spartanburg, SC, 29302, US

(21) Appl. No.: 10/866,906

(22) Filed: Jun. 14, 2004

Related U.S. Application Data
(60) Provisional application No. 60/496,342, filed on Aug. 20, 2003.

(51) Int. Cl. G08B 1/08

(52) U.S. Cl. 340/539.32

(57) ABSTRACT

A remote controlled tree stand or hunting blind locating device which utilizes an LED having a substantially 360° light output which may be remotely activated by a user activated control device. The LED may be selectively activated in either a continuous or flashing mode by the paired activator. Due to the fact that the LED provides a 360° view angle, the functionality of the device is not dependent upon a user approaching from a particular angle.

### CROSS-REFERENCE TO RELATED APPLICATION

This application claims the benefit of and priority from U.S. Provisional Application 60/496,342 filed Aug. 20, 2003 in the name of Gary Hogg, the contents of which are hereby incorporated herein in their entirety.

### TECHNICAL FIELD

The present invention relates generally to a remote controlled location device and more particularly to a radio frequency remote activated position location device incorporating a light emitting diode (LED) positioned to provide a substantially 360° view angle of light emission. The LED may be activated in either a continuous or flashing mode using a hand-held remote activation device or a long-range radio transmitter such has a hand-held two-way radio (i.e. walkie-talkie) or the like. The position location device is particularly suited for use in identifying the position of a tree stand or other wilderness location used by hunters, wildlife photographers. The device is also useable by bicyclists and the like due to the LED discharge which permits position identification around a substantially 360 degree approach radius.

### BACKGROUND

It is well know that outdoor activities involving interaction with wildlife such as hunting, and wildlife photography are often carried out in the early portion of the day immediately following sunrise. This period of the day is normally considered to offer an optimal opportunity for encountering wildlife due to the high levels of activity by wildlife at that time. When engaging in such activities in order to avoid undue disruption which may frighten the wildlife away, it is often desirable for the hunter or photographer to prepare a fixed viewing location prior to the activity and to then take a position at that location before sunrise so as to be fully prepared for the wildlife interaction.

The pre-prepared position may be elevated such as a tree stand or may be located at ground level such as a camouflage blind or pre-identified spot provided with natural organic coverage. In any event, if a user is to assume his or her desired position before sunrise, it is necessary to travel to and locate the pre-identified position during hours of darkness. As will be appreciated, even with the availability of lanterns, flashlights or other devices to illuminate the foot path being traveled, during the hours of darkness it may nonetheless be quite difficult to identify a particular tree, clearing, rock out-cropping, or other pre-identified location where the person desires to take up his or her position. Moreover, if a hunter or photographer becomes at all disoriented he or she may approach the pre-identified location from an angle different from the angle originally contemplated.

In order to address the need to locate such pre-identified wilderness locations in the dark, it is known to use techniques such as using reflective tape and the like to mark these positions. However, such techniques are dependent upon the user having the ability to apply a flashlight beam or other light source onto the position of the reflector. This may be difficult to do if the user becomes disoriented and/or approaches the position from the wrong direction. Moreover, since numerous people may have identified locations within a relatively close proximity to one another such as on a public land parcel, it may be possible to mistake one's own pre-identified location for a location identified and marked by another person.

### SUMMARY OF THE INVENTION

The present invention provides advantages and alternatives over the prior art by providing a remote controlled locating device which utilizes an LED having a substantially 360° concentrated light output which may be remotely activated by a hand-held control device similar to a remote key latch device or through use of a matched frequency long-range transmitter such as an adapted two-way radio. The LED may be selectively activated in either a continuous or flashing mode by the paired activator. Due to the fact that the LED provides a 360° view angle, the functionality of the device is not dependent upon a user approaching from a particular angle. A concave LED cover directs light emission radially so as to enhance the intensity of light emission in the radial direction. Moreover, since the activator and LED display are paired one to the other, a user is assured of approaching only his or her pre-identified location rather than that of another person. This avoidance of potential confusion may represent a substantial safety advantage as the user of the device may be less likely to approach a position already occupied by another hunter in the darkness and thereby avoid being confused with an approaching animal.

### BRIEF DESCRIPTION OF THE DRAWINGS

The present invention will now be described by way of example only, with reference to the accompanying drawings which constitute a portion of the specification herein and wherein:

FIG. 1 illustrates an exemplary tree stand arrangement with an activated position locator device and hand-held activator;

FIG. 2A is an elevation top view of a position locator device;

FIG. 2B is a side view of the position locator device illustrated in FIG. 2A;

FIG. 2C is an end view of the position locator device illustrated in FIG. 2A;

FIG. 3A is a block diagram for the receiver and control unit controlling operation of the position locator device;

FIG. 3B is a block diagram for the activator transmitter which activates the position locator device; and

FIG. 4 is an exploded view illustrating an exemplary assembly for the position locator device.

While the present invention has been generally described above and will hereinafter be described in greater detail in relation to certain illustrated and potentially preferred embodiments, procedures, and practices, it is to be understood that in no event is the invention to be limited to such illustrated and described embodiments, procedures, and practices. Rather, it is intended that the invention shall extend to all embodiments, procedures, and practices as may be embodied within the broad principles of the inventive concepts disclosed herein.

### DETAILED DESCRIPTION OF THE PREFERRED EMBODIMENTS

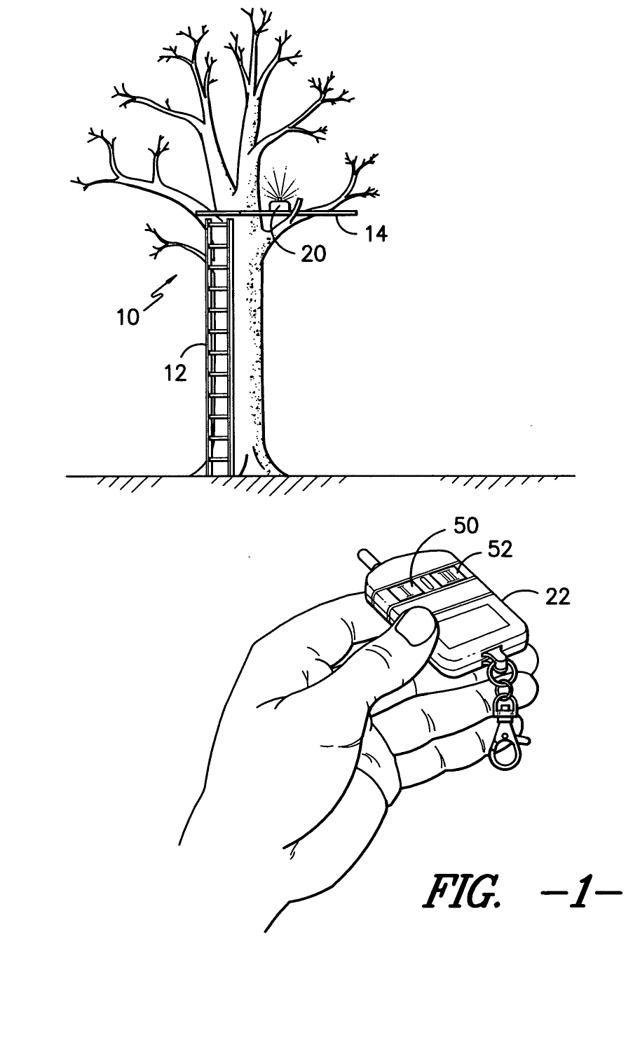

Reference will now be made to the various figures wherein, to the extent possible like elements are designated by like reference numerals throughout the various views. In FIG. 1 there is illustrated a simplified tree stand arrangement 10 including an access ladder 12 and supporting platform 14. Of course, it is to be understood that this arrangement is exemplary only and that the tree stand itself may take on any number of arrangements as will be well known to those of skill in the art. Moreover, it is to be understood that while the present invention is believed to be highly useful in the location of elevated positions such a tree stand, it is in no way limited to such use. Accordingly, it is contemplated and intended that the present invention is equally adaptable to use in the identification of ground level wilderness locations such as duck blinds, turkey blinds, campsites and the like. It may also be adapted for numerous other uses including locating of an automobile within a parking lot, use as a bicycle safety light, use in lighting a photographic darkroom, use in lighting a tent, use in attached relation to a pet, and use as a personal emergency light if desired. Of course, any number of other uses may also occur to those of skill in the art.

As illustrated in FIG. 1, a remotely activated location device 20 may be placed on a portion of the tree stand arrangement 10. It may also be supported in hanging relation to a portion of the tree stand arrangement. The location device 20 may be remotely activated by a signal generating activation unit 22 such as a hand held unit incorporating a SAW (surface acoustic wave) transmitter or the like similar to a remote lock activation unit as will be well know to those of skill in the art. As shown, during activation, the location device 20 emits a light signal around substantially a full 360° radius so as to be equally visible from any angle of approach.

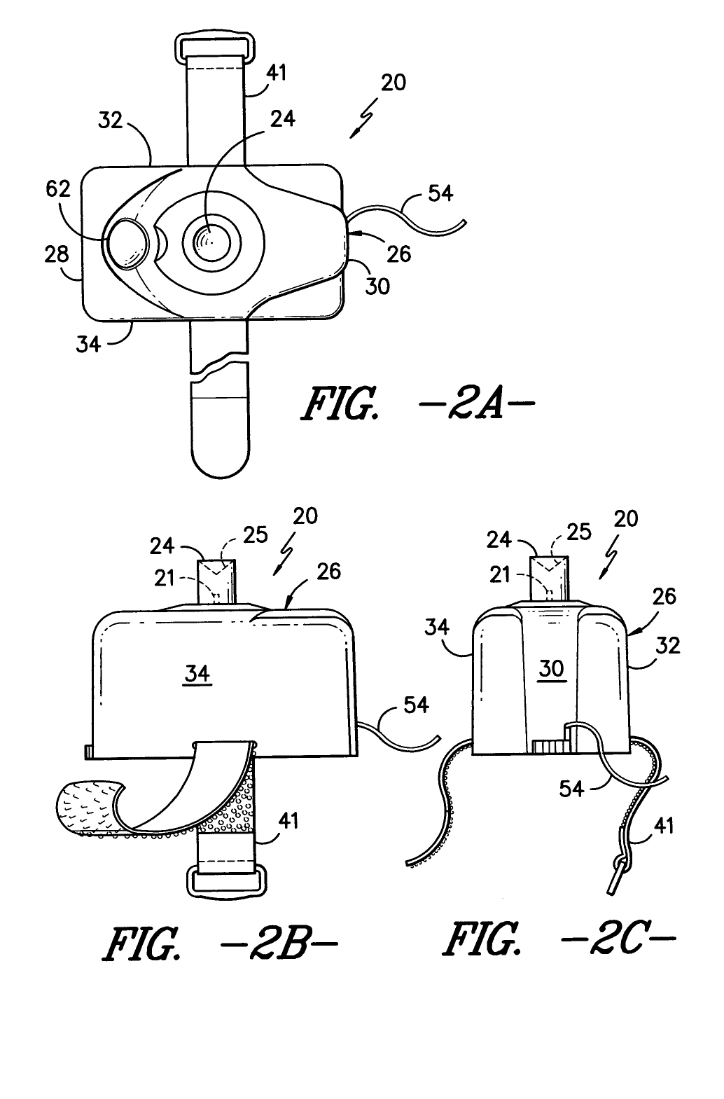

Referring to FIGS. 2A-2C, one exemplary and potentially preferred construction of the location device 20 is illustrated. As shown, in this configuration, the location device 20 includes an outwardly projecting light element 21 such as a light emitting diode (LED) with a translucent covering 24 formed from material such as translucent colored or uncolored plastic or the like. If desired, the light element 21 and the covering 24 may be incorporated within an integral unit. Moreover, the covering may be colored to enhance visual perception.

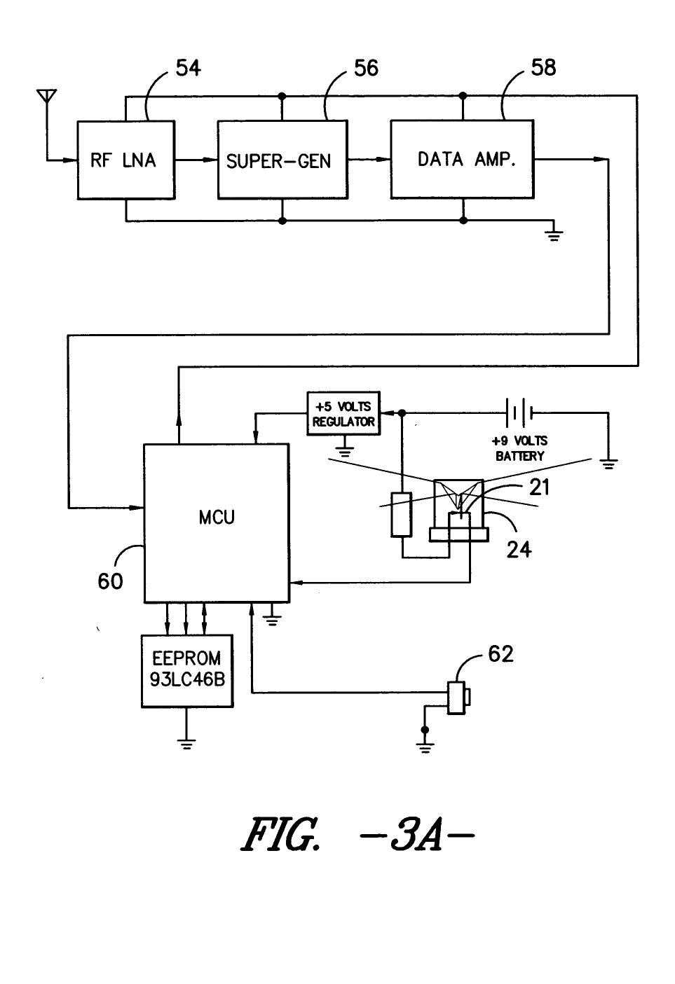

As previously indicated, the location device 20 is configured to project light iaround a full 360° radius. In order to enhance this transmission, in the illustrated configuration the covering 24 may be provided with a concave depression 25 across an upper surface of the covering opposing the light element 21. As shown, the concave depression includes an apex projecting towards the light element 21. Such a concave depression may facilitate the projection of light in a radial direction by at least partial reflective deflection of the light emitted from the light element 21 so as to cause a greater portion of the light to pass outwardly in a radial direction through the side walls (FIG. 3A). In the illustrated configuration the covering 24 is substantially cylindrical. However, other configurations may also be utilized if desired.

The batteries and electronic circuitry which operate the location device 20 are housed within a body portion 26 of molded plastic of the like suitable to form a seal against moisture incursion. As shown, the body portion 26 is preferably molded in a substantially open-bottom box-like construction. As shown, in the illustrated construction the body portion 26 includes a first end 28, a second end 30, and lateral side walls 32, 34 extending between the ends.

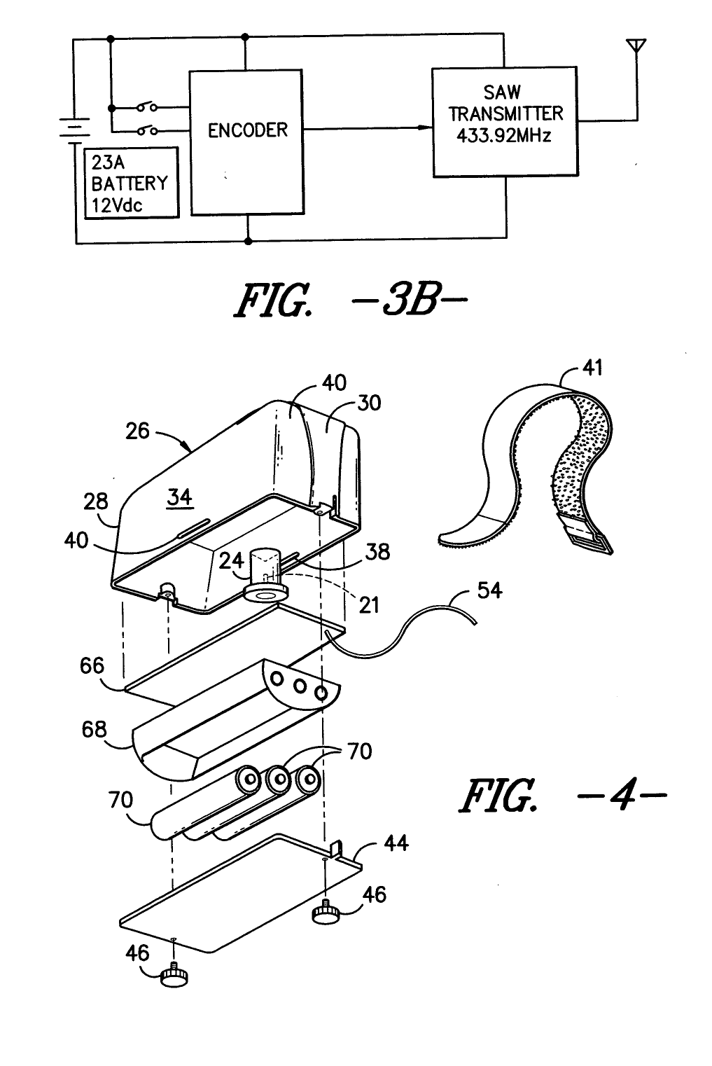

As best illustrated through simultaneous reference to FIGS. 2A and 2C as well as the exploded assembly view in FIG. 4, the body portion 26 may be enclosed across its open bottom by use of a removable plate 44 held in place by thumb screws 46. In the illustrated arrangement, the lateral side walls 32, 34 include opposing slot openings 38, 40 disposed below the seated position of the removable plate 44 for acceptance of a strap element 41 for attachment to a support structure such as a portion of the tree stand platform, tree branch, backpack, bicycle, user wrist or ankle or the like. Thus, when the strap element 41 is threaded through the slot openings 38, 40, the strap element is disposed in underlying supporting relation to the plate 44. This aids in preventing the plate 44 from being mistakenly displaced even if the thumb screws 46 or other attachment devices are lost. As shown, it is contemplated that an interior surface of the strap element 41 may include cooperating zones of hook and loop fabric to facilitate easy attachment and release relative to a selected support structure.

Referring to FIGS. 3A and 3B simultaneously, it is to be understood that in operation the activation unit 22 (FIG. 3B) may utilize a SAW (surface acoustic wave) transmitter so as to provide a low noise amplitude radio frequency signal to the location device 20. This signal will typically include both a carrier portion and a data or instruction portion. Referring simultaneously to FIGS. 1 and 3B, according to one potentially preferred practice, the activation unit 22 may provide a choice of multiple operating instructions. By way of example only, in the illustrated system, the activation unit 22 includes a multi-modal activation switch 50 and a remote termination switch 52. By way of example only, and not limitation, according to one system set up, when the activation switch 50 is depressed once, an instruction signal is sent via the transmitter to the location device 20 for activation of the light element 21 in a flashing or strobe mode. When the activation switch is depressed again, an instruction signal is sent via the transmitter to the location device 20 for activation of the light element 21 in a continuous illumination mode. As will be appreciated, this dual operation mode corresponds to the illustrated use of two switch gates feeding to the encoder in FIG. 3B. When the location device is in either a continuous or flashing illumination mode, illumination may be terminated on demand by depression of the termination switch 52

As illustrated in FIG. 3A, the signal from the activation unit 22 is received at a radio frequency low noise antenna 54 mounted at the location device 20. The signal is then passed to a super generator receiver 56 which demodulates the signal so as to strip away the carrier while retaining the data portion of the signal. The date portion of the signal is thereafter communicated to a data amplification unit 58 for transmission to a pre-programmed master control unit or MCU 60 which process instructions based on an EEPROM (electronically erasable programmable read-only memory). As will be appreciated, an EEPROM retains its contents even when power is turned off or lost. Based on the received data, the master control unit activates the light element 21 such as a super bright tower LED so as to operate in a pre-programmed manner. Exemplary programs may include continuous illumination, flashing illumination, timed illumination, and the like.

A push button control switch 62 or the like mounted on the body portion 26 may be used to place the system in an active or an inactive state. In the active state the receipt of an activation signal as described above will cause the light element to be illuminated in the programmed manner. However, in the inactive state, an activation signal is ignored and no lighting occurs. The push button control switch may also be used as a master shut off for the location device after illumination has commenced.

By way of example only, a contemplated assembly practice is illustrated in FIG. 4. As shown, according to this practice, the light element 21 and corresponding translucent covering (which is preferably in the form of an integral unit) is mounted on a printed circuit board 66 housing the various control components of the location device 20. Of course, it is also contemplated that an integrated circuit may be used in place of the printed circuit board if desired. A battery containment and power transmission panel 68 which is adapted to hold an arrangement of replaceable batteries 70 is mounted below the printed circuit board to form an electrical connection therewith so as to permit the transfer of power from the batteries 70 to the components of the printed circuit board 66. Finally, the bottom plate 44 may be attached via thumb screws 46 so as to provide a field containment arrangement. Of course, any number of other assembly techniques and practices may be utilized.

While the invention has been illustrated and described in relation to certain exemplary embodiments, it is to be understood that such embodiments are exemplary and illustrative only. Accordingly, there is no intention that the present invention should be limited to any of these illustrated and described embodiments. Rather, it is contemplated that any number of other modifications and variations may become apparent to the skilled practitioner upon review of the present specification and/or through practice of the invention described herein. Thus, it is intended to cover all such modifications and variations as may fall within the full spirit and scope of the inventive principles as described herein.

1. A remotely activated system for identifying the location of a tree stand or hunting blind in darkened conditions, the system comprising:
a user controlled signal transmitting activation device for transmission of a radio frequency activation signal; and
a signal receiving illumination device for receipt of the activation signal from the activation device, wherein the illumination device comprises a body portion and a light emitting diode illuminated in response to the activation signal, wherein the light emitting diode is covered by a substantially translucent covering projecting outwardly in raised relation to a surface of the body portion and wherein the translucent covering comprises a concave exterior surface including an apex projecting towards the light emitting diode in opposing relation to the light emitting diode such that upon activation the light emitting diode projects visible light around substantially a 360° radius.

2. The invention as recited in claim 1, wherein the light emitting diode may be illuminated in an intermittent manner so as to project intermittent flashes of visible light.

3. The invention as recited in claim 1, wherein the covering is colored.

4. The invention as recited in claim 1, wherein the activation device comprises a surface acoustic wave transmitter.

5. The invention as recited in claim 4, wherein the activation device is adapted to transmit an activation signal selected from at least two choices.

6. The invention as recited in claim 5, wherein the activation device is adapted to transmit an activation signal to the illumination device causing the light emitting diode to be continuously illuminated.

7. The invention as recited in claim 5, wherein the activation device is adapted to transmit an activation signal to the illumination device causing the light emitting diode to be intermittently illuminated so as to project intermittent flashes of visible light.

8. The invention as recited in claim 1, further comprising an access plate for sealing an access opening in the body portion.

9. The invention as recited in claim 8, further comprising a strap element disposed in threaded relation through a pair of opposing openings disposed within the body portion such that the strap element extends in underlying supporting relation to the access plate.

10. A remotely activated system for identifying the location of a tree stand or hunting blind in darkened conditions, the system comprising:
a user controlled signal transmitting activation device for transmission of a radio frequency activation signal; and
a signal receiving illumination device for receipt of the activation signal from the activation device, wherein the illumination device comprises a body portion, a strap element disposed in threaded relation through a pair of opposing openings disposed within the body portion and a light emitting diode illuminated in response to the activation signal, wherein the light emitting diode is covered by a substantially translucent covering projecting outwardly in raised relation to a surface of the body portion such that upon activation the light emitting diode projects visible light around substantially a 360° radius.

11. The invention as recited in claim 10, wherein the light emitting diode may be illuminated in an intermittent manner so as to project intermittent flashes of visible light.

12. The invention as recited in claim 10, wherein the covering is colored.

13. The invention as recited in claim 10, wherein the activation device comprises a surface acoustic wave transmitter.

14. The invention as recited in claim 13, wherein the activation device is adapted to transmit an activation signal selected from at least two choices.

15. The invention as recited in claim 14, wherein the activation device is adapted to transmit an activation signal to the illumination device causing the light emitting diode to be continuously illuminated.

16. The invention as recited in claim 14, wherein the activation device is adapted to transmit an activation signal to the illumination device causing the light emitting diode to be intermittently illuminated so as to project intermittent flashes of visible light.

17. A remotely activated system for identifying the location of a tree stand or hunting blind in darkened conditions, the system comprising:
a user controlled signal transmitting activation device for transmission of a radio frequency activation signal; and
a signal receiving illumination device for receipt of the activation signal from the activation device, wherein the illumination device comprises a body portion, a strap element disposed in threaded relation through a pair of opposing openings disposed within the body portion and a light emitting diode illuminated in response to the activation signal, wherein the light emitting diode is covered by a substantially translucent covering projecting outwardly in raised relation to a surface of the body portion and wherein the translucent covering comprises a concave exterior surface including an apex projecting towards the light emitting diode in opposing relation to the light emitting diode such that upon activation the light emitting diode projects visible light around substantially a 360° radius.
